(19) United States
(12) Patent Application Publication
(10) Pub. No.: US 2002/0041360 A1
(43) Pub. Date: Apr. 11, 2002

(54) Moving picture display method

(75) Inventors: Masahiro Kawano, Tokyo (JP); Yutaka Inoue, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Kabushiki Kaisha NTTAd, Tokyo (JP)

(21) Appl. No.: 09/943,092

(22) Filed: Aug. 29, 2001

Related U.S. Application Data
(63) Continuation-in-part of application No. 09/554,816, filed on Sep. 22, 1999.

(30) Foreign Application Priority Data
Sep. 22, 1998 (JP) 10-268062
Sep. 22, 1999 (JP) PCT/JP99/05193

(51) Int. Cl. G03B 19/18

(52) U.S. Cl. 352/38

(57) ABSTRACT

A method of displaying still images as a motion picture by sequentially displaying, at predetermined intervals, still frames representing the motion of some object being displayed is disclosed. The display method includes receiving a series of still images taken periodically of an object in motion, dividing the series of still images into small segments according to the continuous motion states of the object, and sequentially displaying frames representing the beginning of each of the object's continuous motion states followed by a frame representing the end of the object's final continuous motion state.

### CROSS-REFERENCES TO RELATED APPLICATIONS

The present application is a Continuation-in-Part of Application No. 09/554,816, filed Sep. 22, 1999. The disclosure of that application is incorporated herein by reference.

### BACKGROUND OF THE INVENTION

The present invention relates to a method of displaying the motion of a person or thing as a moving object on the display of a personal computer or the like.

The conventional method for creating the optical illusion of motion shown on a display unit such as a CRT of a personal computer is to sequentially display, at predetermined intervals, still images of a person or thing in different positions of movement. According to television, movie, or motion picture standards, such as Motion Pictures' Experts Group (MPEG), 25 to 30 still frames must be sequentially displayed per second to create the optical illusion of a moving picture showing a smooth, continuous, and natural motion.

In conventional display techniques, the still images displayed represent periodic snapshots of the state of the object in motion. For example, when a person is photographed by a motion picture camera, his appearance is captured approximately once every 33 milliseconds. If the motion picture film is played back directly, or is digitized and played back on a computer display, the still images will be displayed at the same frequency they were recorded.

In recent years, the CRT of a personal computer displays a charming animated character to entertain the computer operator as he performs various tasks on the computer. To avoid interfering with other computer operations, the storage and processing loads of a central processing unit (CPU) required to display such a character must be kept to a minimum. To consistently illustrate a smooth, continuous, and natural motion on personal computers about five still frames must be displayed per second. Similarly, the same requirement applies when an image of a person is selected to be displayed instead of an animated character.

Unfortunately, problems arise when a sequence of images meant to be displayed at some high frequency is sub-sampled and displayed at a lower frequency. For example, suppose a computer is to display a series of still images representing a hand reaching for, grasping, and lifting a can of soda from a table top. If the original sequence of images is meant to be displayed at 30Hz, it will probably contain enough still images to represent the approach of the hand, the hand grasping the can and the hand lifting the can. If all of these images are displayed, the motion will appear smooth, natural and, continuous. If, however, the sequence is sub-sampled in order to reduce the number of frames displayed in a given amount of time, a frame containing crucial information about the motion state of the object may be omitted. It is possible, for example, that the frames representing the grasping of the can will be omitted in order to reduce the frame frequency from 30Hz to 5Hz. If this occurs, the hand may appear to jump from one portion of the display to another, its motion appearing unnatural and discontinuous.

The quality of motion can, of course, be enhanced by increasing the number of still frames displayed per second. However, because the storage and processing loads of a CPU must be kept at a minimum, the number of still frames that could be displayed per second is limited and cannot be increased.

What is needed is a method that selectively displays at least those still images which show the transitions between different states of continuous motion. This will result in a display which gives the viewer a more accurate sense of the motion of the object with a while displaying a minimal number of frames.

### BRIEF SUMMARY OF THE INVENTION

The present invention overcomes the conventional drawback and solves the problem by providing a motion picture display method that eliminates any unnatural motion even though only a small number of still frames are displayed per second. The present invention provides a method for displaying still images of an object as a moving picture by sequentially displaying, at predetermined intervals, still frames representing motion states of the object. The display method comprises the steps of receiving a series of still images of an object representing the state of the object at regular time intervals, grouping the still frames into small segments in accordance with continuous motion states of the object and displaying at least two frames per each small segment: one frame representing the start of the object's continuous motion state and one frame representing the end of the object's continuous motion in a particular direction.

For example, the method of the present invention as described may be used to illustrate the motion of holding and raising an object. Using the method of the present invention, the series of still frames is classified into two small segments. The first small segment is composed of the still frames that show a hand reaching for the object. This small segment begins when the hand starts in motion toward the can, and ends when the hand has stopped moving, having grasped the can. A second small segment is composed of the still frames that show the hand holding the object and raising it. This small segment is defined by the hand moving up away from the table.

To display a smooth and natural motion from one state to another with a small number of frames, the first and last frames of each small segment are displayed without any omission. That is, for the first small segment, the first frame in which the hand is away from the object and the last frame in which the hand is on the object are prepared, and the two frames are displayed at an interval of 0.2 seconds apart. For the second small segment, the first frame in which the hand holds the object and the last frame in which the hand raises the object to a predetermined height are prepared, and the two frames are similarly displayed at an interval of 0.2 seconds apart. In this manner, the first and last frames of each small segment are displayed without any omission. As illustrated by this simple example, the method gives a viewer an accurate sense of the motion of the hand while displaying a small number of frames.

### BRIEF DESCRIPTION OF THE DRAWINGS

FIG. 1 illustrates an image display method according to an embodiment of the claimed invention.

### DETAILED DESCRIPTION OF THE INVENTION

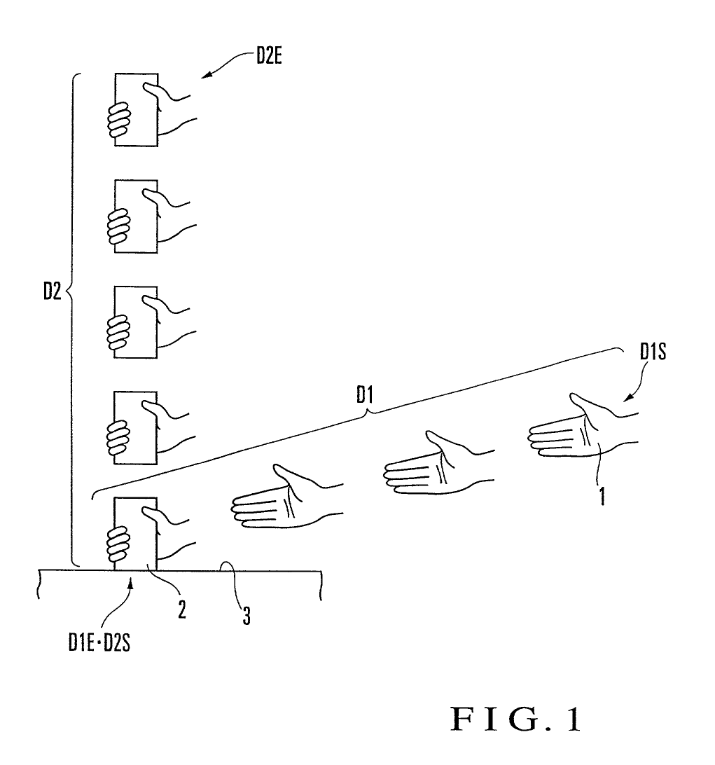

FIG. 1 shows a series of still frames as hand 1 raises can 2 on table 3. To show accurate motion, the still frames are categorized into small segments. The segments are formed by grouping those still frames that illustrate one continuous motion state. The object displayed can be said to be in a continuous motion state if it is stationary for at least two frames, or if its direction of motion is unchanged for at least two frames. For example, in FIG. 1, the motion of hand 1 reaching to grab hold of can 2 is categorized as the first small segment D1, and the motion of raising can 2 is categorized as the second small segment D2. The first small segment D1 contains a total of 4 frames. These frames represent the state of the hand 1 at regular intervals. According to the method of the present invention, only frames D1S and D1E, the frames representing the start and end of the hand's 1 motion toward the can 2, are displayed. Similarly, small segment D2 consists of 5 still frames. According to the present invention, only D2S and D2E, which represent the start and end of the hand's 1 motion from the tabletop 3 are displayed.

It will be noted that in the method of the present invention, the last frame of a small segment is always the first frame of the subsequent small segment. Accordingly, in the example of FIG. 1, the method only displays the frame corresponding to both D1E and D2S once.

The method of the present invention allows frames within a small segment to be omitted, thereby reducing the total number of frames displayed, while still giving the viewer a sense of the complete motion of the hand.

In one embodiment of the present invention, the frames D1S, D1E, and D2E are displayed at 0.2 second intervals to result in a display rate of 5Hz. In an alternative embodiment, intervening frames within the small segments may be added to provide more continuity as data processing resources allow.

According to the present invention, a small segment of still frames is defined not only by a change in the direction of the motion of the object displayed, but also by a motion state discontinuity. For example, if the hand 1 of FIG. 1 stopped midway between its starting position represented by frame D1S and its ending position represented by frame D1E, the previously defined small segment D1 would be subdivided into two new small segments defined by the periods of the hand's constant motion. If the hand stayed motionless for at least two successive frames, its lack of motion would be defined as a continuous motion state according to the method of the present invention. This would result in the definition of a third small segment in the middle of the previously defined segment D1.

This embodiment does not include images that show the fingers stretching, bending and grasping can 2. If hand 1 is zoomed in so as to display images of the fingers bending to grab can 2 several new small segments would be created that could be inserted between the first and second small segments, D1 and D2. These new small segments would be defined by the direction of motion of various parts of the hand 1. For example, the fingers moving from their closed to their open position would mark a small segment, and the motion of the fingers from open to grasping the can would mark another small segment.

This embodiment has exemplified the motion of a hand as part of the body and can be applied to the motion of the whole body such as walking. Alternatively, a person's image may be extracted from a picture excluding any background to create an image to be used as an icon for a personal computer or the like. In this case, a person is sensed by a so-called blue matter process, and the person's image undergoes image processing by a computer to extract only the person's image.

As is apparent from the above description, the present invention provides a method for displaying accurate motion by displaying a small number of still frames. The exact means of implementing the method of the present invention on a computer will be evident to those of ordinary skill in the art. For example, data representing a series of still images could be stored in some memory device on a computer. The method of the present invention could then be applied to said data to generate a new, smaller series of images to be displayed. Alternatively, the method of the present invention could be applied to a series of images stored in some memory device external to a computer. The smaller series of images resulting from the application of the method to the periodically sampled series of images could then be transferred to a computer for display. Alternatively, software which generates images of an object in motion could be configured to only generate images for display that were representative of the beginning and end of the object's continuous motion states.

The description above provides a full and complete disclosure of the preferred embodiments of the present invention. Various modifications, alternative constructions, and equivalents will be evident to those with skill in the art. Thus, the scope of the present invention is limited only be the metes and bounds of the appended claims.

What is claimed is:

1. A method for displaying the motion of a person or other object in a motion picture by successively displaying, at predetermined intervals, frames of still images that represent motion states of the person or thing, comprising the steps of:
receiving an ordered sequence of still image frames taken periodically that represents the state of the object over time;
dividing the sequence into an ordered series of small segments such that each small segment represents one continuous motion state of the object, the small segments comprising at least a first still frame representing the beginning of a continuous motion state of the object and a last still frame representing the end of a continuous motion state of the object;
displaying the first still frame of each small segment in the order of the ordered series of small segments, followed by the last still frame of the last small segment in the series;
wherein the object is in a continuous motion state if it is stationary for at least two successive frames or its direction of motion is unchanged for at least two successive frames in the original sequence of still image frames.

2. A method for displaying the motion of a person or other object on a computer, having in memory an ordered sequence of still images taken periodically that represents the state of the object over time, comprising the steps of:
dividing the sequence into an ordered series of small segments such that each small segment represents one continuous motion state of the object, the small segments comprising at least a first still frame representing the beginning of a continuous motion state of the object and a last still frame representing the end of a continuous motion state of the object;
displaying the first still frame of each small segment in the order of the ordered series of small segments, followed by the last still frame of the last small segment in the series;
wherein the object is in a continuous motion state if it is stationary for at least two successive frames or its direction of motion is unchanged for at least two successive frames in the original sequence of still image frames.
